(19) United States
(12) Patent Application Publication
(10) Pub. No.: US 2005/0063200 A1
(43) Pub. Date: Mar. 24, 2005

(54) Movable and delay-extinction illuminating apparatus

(76) Inventor: John Lu, Taipei City (TW)

Correspondence Address: BRUCE H. TROXELL, SUITE 1404, 5205 LEESBURG PIKE, FALLS CHURCH, VA, 22041, US

(21) Appl. No.: 10/863,228

(22) Filed: Jun. 9, 2004

(30) Foreign Application Priority Data
Sep. 18, 2003 (TW) 92216790

(51) Int. Cl. F21L 14/02

(52) U.S. Cl. 362/802

(57) ABSTRACT

A movable and delay-extinction illuminating apparatus which can be arranged or hung in a desired position. The illuminating apparatus includes a housing defining a chamber and a transparent shade body disposed on one face of the housing. An illuminating device is received in the chamber. When the illuminating device is turned on, light beam is projected from the illuminating device through the shade body to illuminate the environment. The illuminating device includes an activating unit formed by a photosensitive unit or a switch unit, a time delay unit and a lighting unit. When the switch unit is switched on, the lighting unit is activated to continuously emit light for a certain period of time set by the time delay unit. Thereafter, the lighting unit is automatically gradually extinguished.

### BACKGROUND OF THE INVENTION

The present invention is related to a movable and delay-extinction illuminating apparatus which can be arranged in a desired position. The illuminating apparatus includes a lighting unit controlled by an electronic unit. When switched on, the lighting unit continuously emits light at a set luminance for a certain period of time. Thereafter, the lighting unit is automatically gradually extinguished. Therefore, it is unnecessary to later manually turn off the lighting unit to facilitate use of the illuminating apparatus.

It is known that after using an illuminator, a user needs to manually turn off the illuminator. The switch of the illuminator is generally fixed in a certain position. When a user leaves a room, the user often needs to extinguish all the illuminators in the room. In the case that the switch of the illuminator is fixed in a position not close to the exit of the room, then the user will have to go to the exit in the dark. This is inconvenient and dangerous. Similar situation also often takes place before going to bed. After turning off the light, a user needs to go to the bed in the dark.

In order to solve the above problem, the illuminator is equipped with a bidirectional switch or a bed light is additionally placed beside the bed. By means of the bidirectional switch, the illuminator can be controlled by two switches arranged in two different positions. After the illuminator is switched on by one switch, the illuminator can be switched off by the other switch in the other position. Recently, a movable pat light has been developed. Referring to FIG. 1, the pat light includes a transparent thin housing 1 in which a bulb 10 is disposed. A switch 11 is arranged on back face of the housing 1 and connected with the bulb 10 as shown in FIG. 2. The thin housing 1 can be placed in a desired position. When a user presses the thin housing 1, the switch 11 on the back face of the housing 1 is pressed against the location of the pad light to switch on/off the bulb.

According to the above arrangement, the light still must be turned on/off manually. Moreover, due to negligence or laziness, a user often fails to turn off the illuminator after used. For example, in a cold day, once a user gets into the comforter, the user is often unwilling to get up to turn off the illuminator. Furthermore, after turning off the light, the user needs to go back to the bed in the dark and re-cover himself/herself with the comforter. This is quite inconvenient and needs to improve.

### SUMMARY OF THE INVENTION

It is therefore a primary object of the present invention to provide a movable and delay-extinction illuminating apparatus. The illuminating apparatus includes a lighting unit controlled by an electronic unit. When switched on, the lighting unit continuously emits light at a set luminance for a certain period of time. Thereafter, the lighting unit is automatically gradually extinguished without human operation. Therefore, it won't happen again that due to negligence or laziness, a user fails to turn off the illuminator after used. Accordingly, the energy can be saved.

According to the above object, the movable and delay-extinction illuminating apparatus includes a housing defining a chamber and a transparent shade body disposed on one face of the housing. An illuminating device is received in the chamber. The illuminating device includes a switch unit, a lighting unit and a charging/discharging circuit. When the illuminating device is activated, the switch unit triggers the lighting unit to emit light. Also, after the charging/discharging circuit has been charged for a period of time, the charging/discharging circuit is powered off to discharge. The lighting unit can continuously emit light for a certain period of time until the charge is exhausted.

The above movable and delay-extinction illuminating apparatus further includes a photosensitive element such as photosensitive resistor, phototransistor, photodiode, etc. In the case that the photosensitive element senses that the luminance of the environment goes down to be below a set value, a triggering signal is generated to power on the lighting unit to emit light. After the charging/discharging circuit has been charged for a period of time, the charging/discharging circuit is powered off to discharge. The lighting unit can continuously emit light for a certain period of time until the charge is exhausted.

The above movable and delay-extinction illuminating apparatus can be arranged or hung in a desired position. When the illuminating device is turned on, light beam is projected from the illuminating device through the transparent shade body to illuminate the environment.

In the above movable and delay-extinction illuminating apparatus, the lighting unit is connected with the photosensitive unit or a touch-controlled unit. The photosensitive unit or touch-controlled unit serves to control and power on the lighting unit to emit light.

The above movable and delay-extinction illuminating apparatus further includes a time delay unit for temporarily powering on the lighting unit. When the switch unit is switched on, the lighting unit is activated to continuously emit light for a certain period of time set by the time delay unit. Thereafter, the lighting unit is automatically gradually extinguished without human operation.

The above movable and delay-extinction illuminating apparatus further includes a central microprocessor unit for more accurately and conveniently controlling the lighting duration of the lighting unit.

The present invention can be best understood through the following description and accompanying drawings wherein:

### BRIEF DESCRIPTION OF THE DRAWINGS

FIG. 1 is a perspective view of a conventional illuminating apparatus;

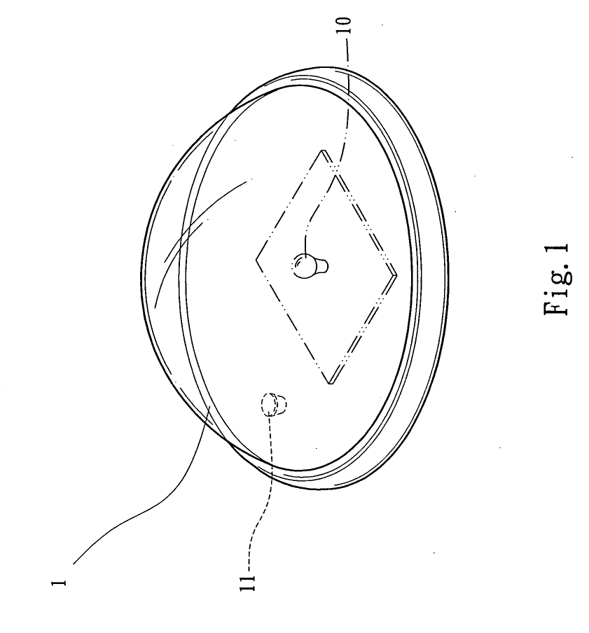

FIG. 2 is a circuit diagram of the conventional illuminating apparatus of FIG. 1;

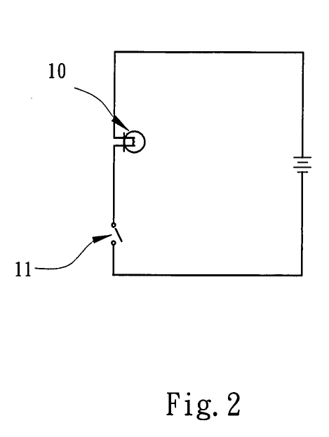

FIG. 3 is a perspective view of the present invention;

FIG. 4 is a perspective view of the present invention, showing the back face thereof;

FIG. 5 is a block diagram of the present invention;

FIG. 6 is a circuit diagram of the present invention;

FIG. 7 is a circuit diagram of another embodiment of the present invention;

FIG. 8 is a circuit diagram of still another embodiment of the present invention;

FIG. 9 is a block diagram of another embodiment of the present invention, which includes a central microprocessor unit;

FIG. 10 is a circuit diagram of the embodiment of FIG. 9;

FIG. 11 is a perspective exploded view of the embodiment of FIGS. 9 and 10; and

FIG. 12 is a perspective view of the embodiment of FIG. 11.

### DETAILED DESCRIPTION OF THE PREFERRED EMBODIMENTS

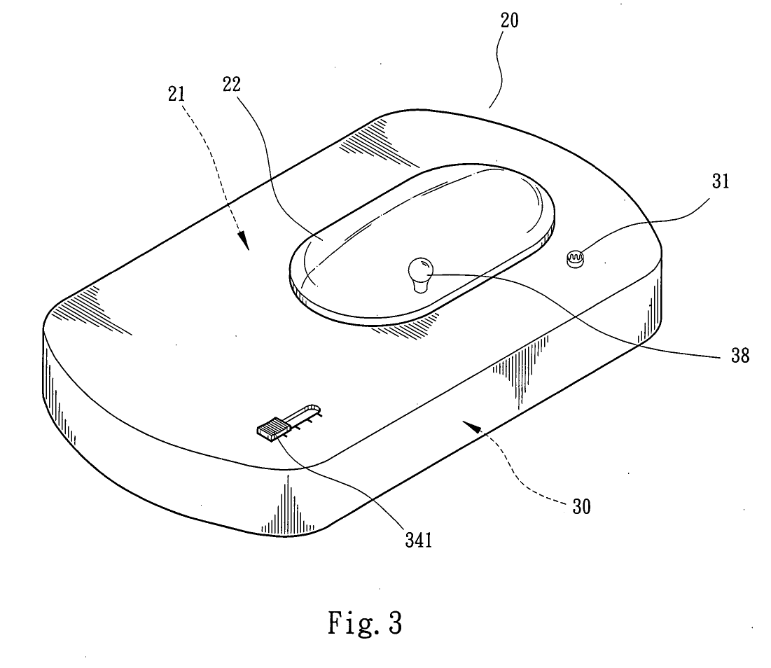

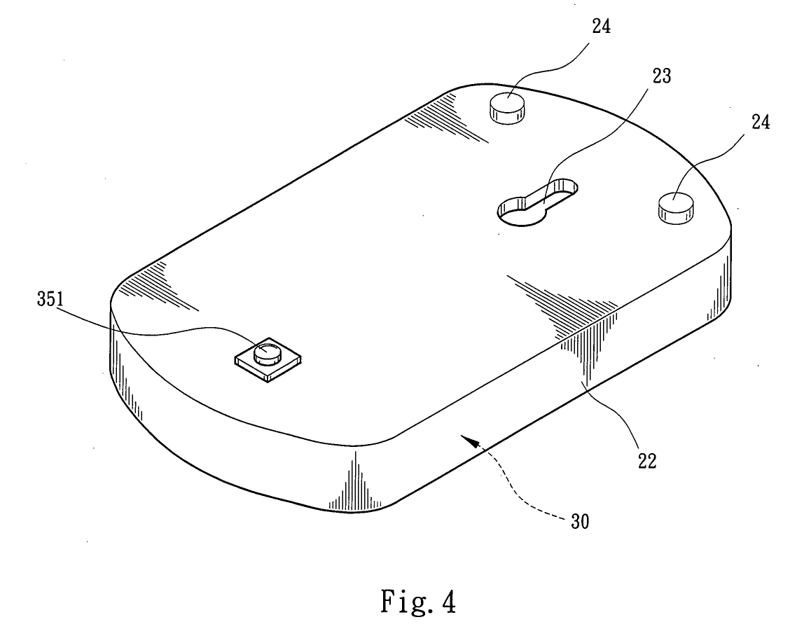

Please refer to FIG. 3. The movable and delay-extinction illuminating apparatus of the present invention includes a housing 20 defining therein a chamber 21 in which an illuminating device 30 is received. A transparent shade body 22 is disposed on one face of the housing 20. When the illuminating device 30 is turned on, a light beam is projected through the shade body 22 to achieve an illuminating effect. A slot 23 and two abutting sections 24 are formed on the other face (rear face) of the housing 20 as shown in FIG. 4 for hanging the illuminating device of the present invention.

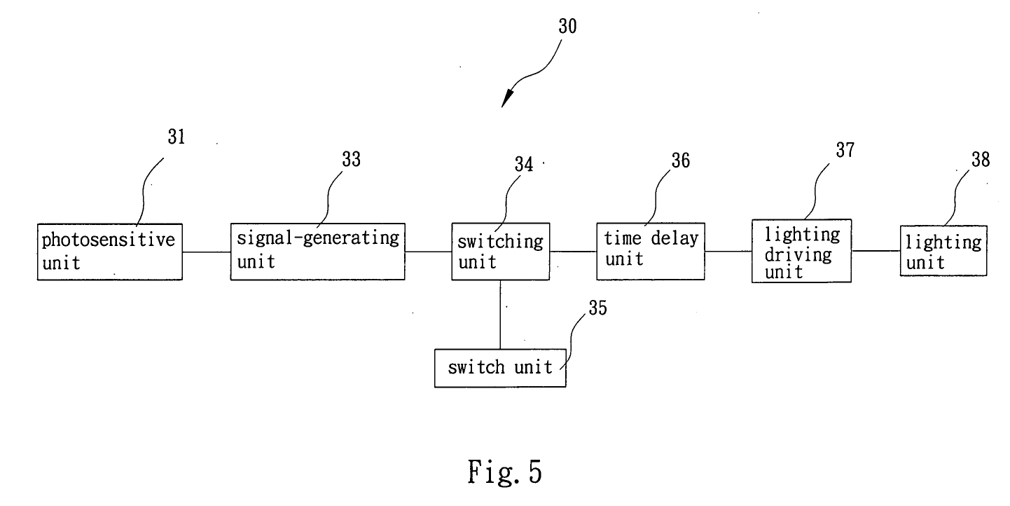

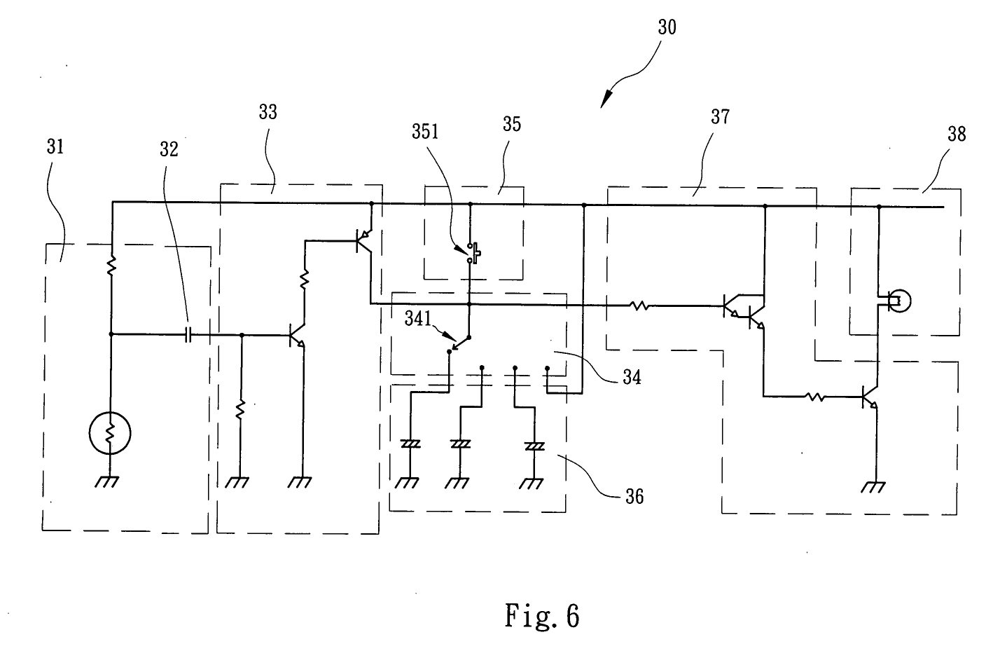

Referring to FIGS. 5 and 6, according to a preferred embodiment of the present invention, the illuminating device 30 includes a switch unit 35 or photosensitive unit 31 as an activating unit. With the photosensitive unit 31 exemplified, the photosensitive unit 31 serves to sense light change of external environment to generate a triggering signal. A capacitor unit 32 is connected with the photosensitive unit 31 for transmitting the triggering signal. A signal-generating unit 33 is connected with the capacitor unit 32 for amplifying the triggering signal to generate a voltage signal. A switching unit 34 is connected with the signal-generating unit 33 to enable a user to select the duration of lighting. In a preferred embodiment, the switching unit 34 is a switch 341 (referring to FIGS. 3 and 6). A switch unit 35 is connected with the switching unit 34. In a preferred embodiment, as shown in FIGS. 4 and 6, when the switch unit 35 is touched and pressed, a voltage signal is generated to activate the circuit. A time delay unit 36 is connected with the switching unit 34 for storing the voltage signal via the capacitance selected by the switching unit 34. The greater the selected capacitance is, the longer the discharging time is. A lighting driving unit 37 is connected with the time delay unit 36 for receiving the discharge of the time delay unit 36 to operate. A lighting unit 38 is connected with the driving unit 37 and controlled by the driving unit 37 to light or blacken. In a preferred embodiment, the lighting unit 38 includes at least one light-emitting diode or bulb as a light source.

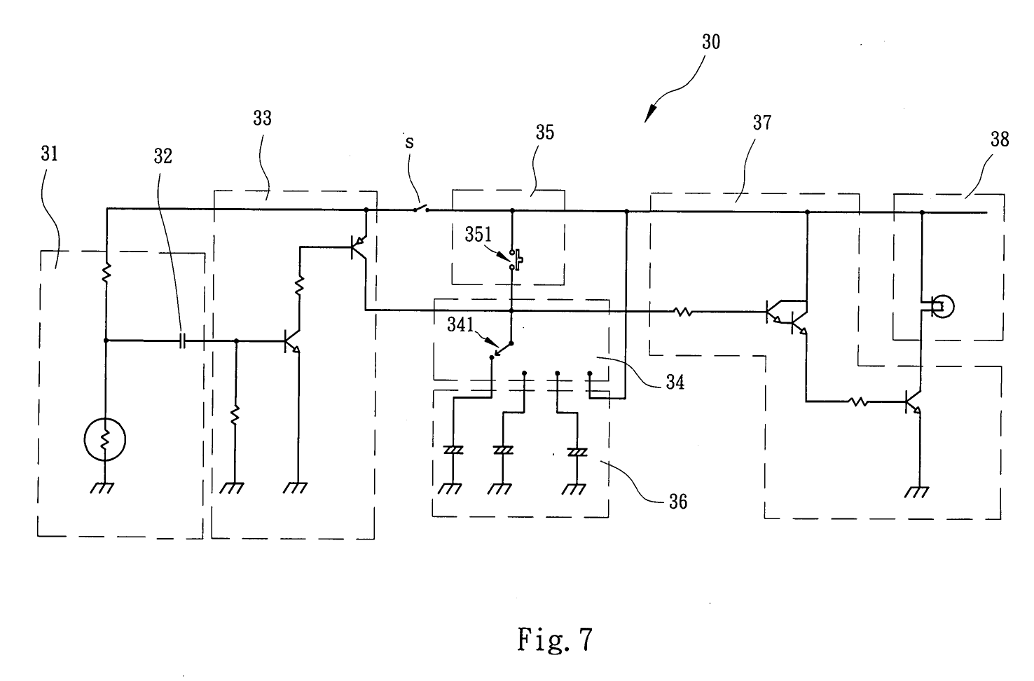

FIG. 7 shows another embodiment of the illuminating device 30 of the present invention, which is different from the embodiment of FIG. 6 in that a switch element S is additionally disposed between the signal generating unit 33 and the switch unit 35. A user can select the photosensitive unit 31 or the switch unit 35 to generate the voltage signal. That is, by means of the switch element S, a user can select the photosensitive unit 31 to sense the luminance of the environment to control the lighting unit 38 to emit light. Alternatively, the user can selectively touch the housing 20 of the illuminating apparatus of the present invention to press the switch unit 35 for turning on the lighting unit 38.

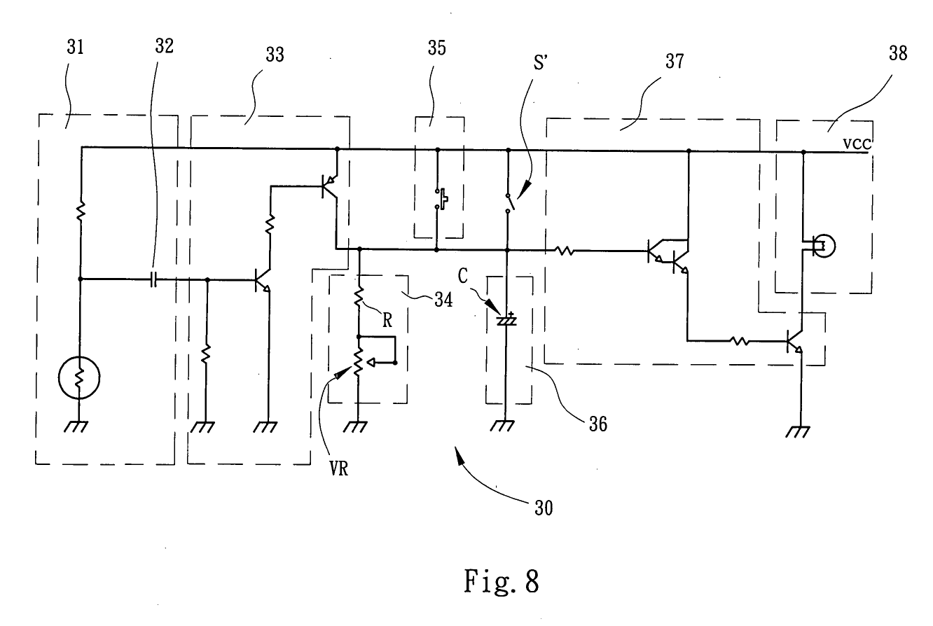

FIG. 8 shows still another embodiment of the illuminating device 30 of the present invention, which is different from the embodiment of FIG. 6 in that a switch element S′ is additionally disposed between the time delay unit 36 and the lighting driving unit 37. When the switch element S′ is pressed down, it means the aforesaid voltage signal is continuously generated. That is, the lighting unit 38 can be continuously controlled and driven by the driving unit 37 to emit light. In addition, originally, the time delay unit 36 stores the voltage signal via the capacitance selected by the switching unit 34. In this embodiment, this is such changed that a resistor R is serially connected with a variable resistor VR (serving as the switching unit 34) and then parallelly connected with a capacitor C (serving as the time delay unit 36). The greater the selected resistance is, the longer the discharging time is. Therefore, the duration of lighting of the lighting unit 38 is longer.

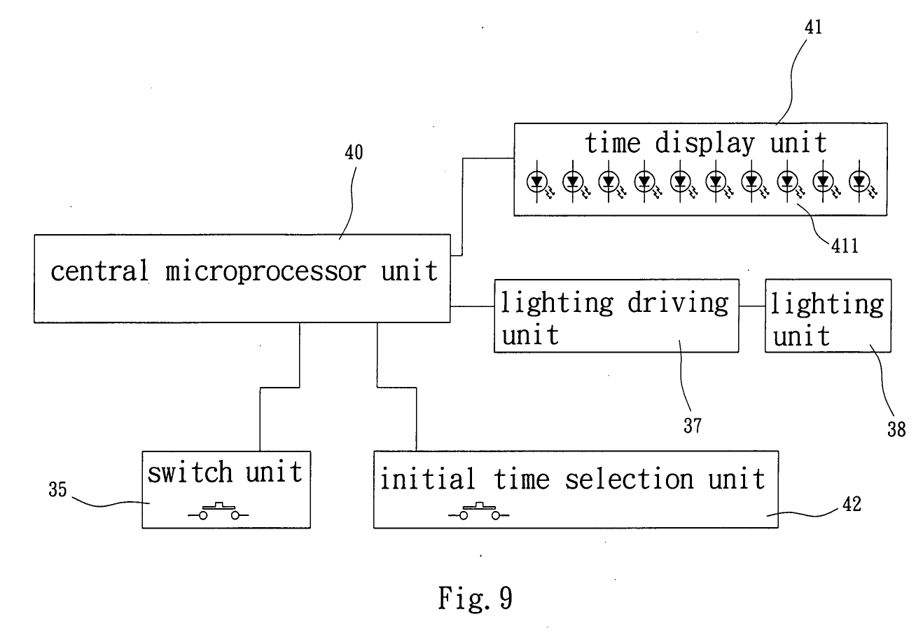

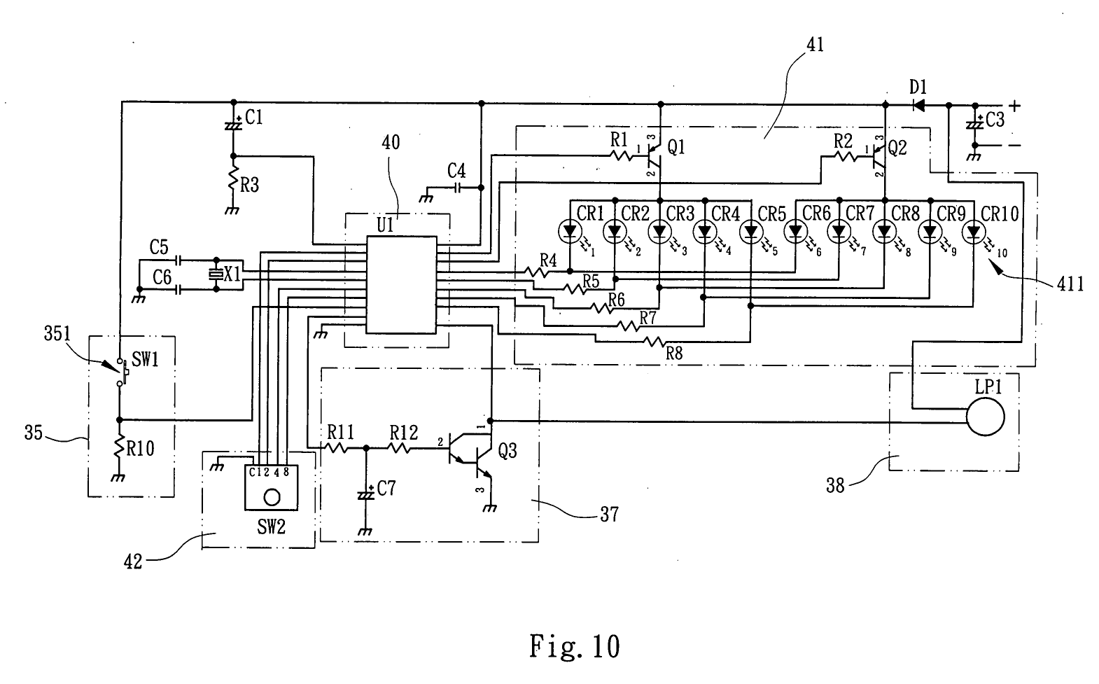

Referring to FIGS. 9 to 12, a microprocessor unit is applied to the movable and delay-extinction illuminating apparatus of the present invention. A central microprocessor unit 40 is connected with the switch unit 35, lighting driving unit 37, lighting unit 38 and time display unit 41 as a whole. The central microprocessor unit 40 serves to control all the units and set the duration. The switch unit 35 is a press button switch. When pressing the switch unit 35, the lighting unit 38 is turned on to emit light and the indicator lamps 411 of the time display unit 41 will be sequentially lighted up. Moreover, according to the duration for which the switch unit 35 is pressed, the number of the lighted indicator lamps 411 can be varied to indicate the synchronously adjusted lighting duration of the lighting unit 38 inside the central microprocessor unit 40. In addition, the central microprocessor unit 40 is further connected with an initial time selection unit 42 for adjustably setting the lighting duration of the lighting unit 38 when the switch unit 35 is initially instantaneously once pressed.

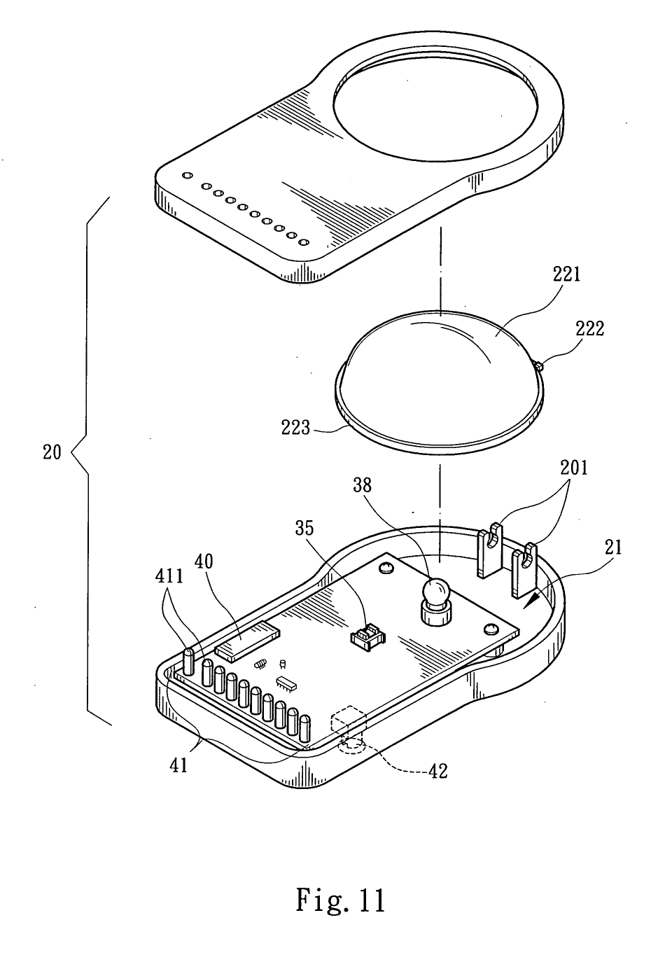

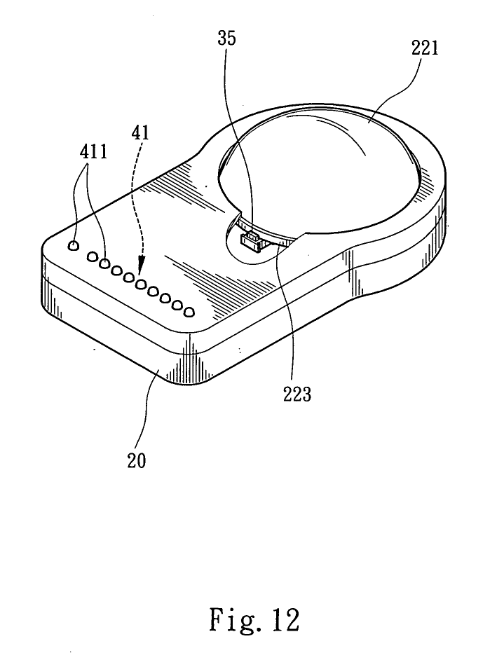

Referring to FIGS. 11 and 12, the switch unit 35 can be disposed in the chamber 21. A transparent shade body 221 is disposed on the housing 20. The shade body 221 can be inward pressed and moved. The bottom edge of one end of the shade body 221 has a pivot section 222 for pivotally connecting with at least one pivot rack 201 disposed on the bottom of the housing 20. A touch section 223 corresponding to the switch unit 35 is disposed on the periphery of the shade body 221 nearly opposite to the pivot section 222. When the shade body 221 is pressed down, the touch section 223 just presses and touches the switch unit 35 to activate the illuminating unit.

According to the above arrangement, the movable and delay-extinction illuminating apparatus of the present invention has the following advantages:
1. The photosensitive unit 31 serves to sense the luminance of the environment. When the environment is dimmed, the illuminating device 30 is activated and the lighting unit 38 automatically emit light to immediately provide an illuminating effect.
2. The extinction of the lighting unit 38 of the illuminating device 30 can be delayed. Therefore, the user can once operate the present invention to turn on the lighting unit 38 and later extinguish the lighting unit 38. This is quite convenient.
3. The illuminating device 30 is equipped with a switching unit 34 connected with the time delay unit 36. By means of the switching unit 34, a user can select a desired extinction delay time to achieve a temporary illuminating effect as necessary.
4. The central microprocessor unit 40 provides more accurate and effective control of duration of lighting to facilitate the use of the present invention.

In conclusion, the movable and delay-extinction illuminating apparatus of the present invention can provide a temporary illuminating effect for a certain time and before delay-extinction. Therefore, in the case that a user needs a short term of illumination, it is unnecessary for the user to go back and forth to operate the switch of the illuminator. Moreover, after a period of illumination, the illuminator of the present invention can be automatically extinguished to save energy.

The above embodiments are only used to illustrate the present invention, not intended to limit the scope thereof. Many modifications of the above embodiments can be made without departing from the spirit of the present invention. For example, the number of the capacitors of the time delay unit can be increased or decreased. The number of the lighting elements of the lighting unit can be increased or decreased. The transistor of the driving unit can be replaced by a relay to achieve equivalent effect.

1. A movable and delay-extinction illuminating apparatus comprising:
a housing defining therein a chamber, a transparent shade body being disposed on one face of the housing; and
an illuminating device mounted in the chamber, the illuminating device including a switch unit, whereby when the switch unit is switched on, a lighting unit of the illuminating device is activated to continuously emit light for a certain period of time, thereafter, the lighting unit being extinguished.

2. The movable and delay-extinction illuminating apparatus as claimed in claim 1, wherein the switch unit is a touch-controlled switch disposed on bottom face of the housing.

3. The movable and delay-extinction illuminating apparatus as claimed in claim 2, wherein at least one abutting section is disposed on the bottom face of the housing for lifting the housing to a certain height.

4. The movable and delay-extinction illuminating apparatus as claimed in claim 1, wherein a photosensitive unit is connected with the lighting device for sensing light change of environment, whereby in the case that the luminance of the environment is below a set value, a triggering signal is generated to the lighting device to emit light.

5. The movable and delay-extinction illuminating apparatus as claimed in claim 1, wherein a switching unit is disposed on one side of the shade body for adjusting the duration of continuous lighting.

6. The movable and delay-extinction illuminating apparatus as claimed in claim 2, wherein a switching unit is disposed on one side of the shade body for adjusting the duration of continuous lighting.

7. The movable and delay-extinction illuminating apparatus as claimed in claim 4, wherein a switching unit is disposed on one side of the shade body for adjusting the duration of continuous lighting.

8. The movable and delay-extinction illuminating apparatus as claimed in claim 1, wherein the lighting device includes a signal-generating unit for amplifying the triggering signal into a voltage signal.

9. The movable and delay-extinction illuminating apparatus as claimed in claim 2, wherein the lighting device includes a signal-generating unit for amplifying the triggering signal into a voltage signal.

10. The movable and delay-extinction illuminating apparatus as claimed in claim 4, wherein the lighting device includes a signal-generating unit for amplifying the triggering signal into a voltage signal.

11. The movable and delay-extinction illuminating apparatus as claimed in claim 1, wherein a slot is formed on the bottom face of the housing for hanging the illuminating apparatus.

12. The movable and delay-extinction illuminating apparatus as claimed in claim 2, wherein a slot is formed on the bottom face of the housing for hanging the illuminating apparatus.

13. The movable and delay-extinction illuminating apparatus as claimed in claim 4, wherein a slot is formed on the bottom face of the housing for hanging the illuminating apparatus.

14. The movable and delay-extinction illuminating apparatus as claimed in claim 1, wherein a time delay unit is inbuilt in the illuminating device, whereby after the illuminating device is activated, the lighting unit will emit light for a period of time set by the time delay unit and then be extinguished.

15. The movable and delay-extinction illuminating apparatus as claimed in claim 2, wherein a time delay unit is inbuilt in the illuminating device, whereby after the illuminating device is activated, the lighting unit will emit light for a period of time set by the time delay unit and then be extinguished.

16. The movable and delay-extinction illuminating apparatus as claimed in claim 4, wherein a time delay unit is inbuilt in the illuminating device, whereby after the illuminating device is activated, the lighting unit will emit light for a period of time set by the time delay unit and then be extinguished.

17. The movable and delay-extinction illuminating apparatus as claimed in claim 1, further comprising a central microprocessor unit connected with the switch unit, the central microprocessor unit serving to control all the units connected therewith and set the duration of lighting of the illuminating device, whereby according to the duration for which the switch unit is activated, the lighting duration of the illuminating device is adjusted via the central microprocessor unit.

18. The movable and delay-extinction illuminating apparatus as claimed in claim 2, further comprising a central microprocessor unit connected with the switch unit, the central microprocessor unit serving to control all the units connected therewith and set the duration of lighting of the illuminating device, whereby according to the duration for which the switch unit is activated, the lighting duration of the illuminating device is adjusted via the central microprocessor unit.

19. The movable and delay-extinction illuminating apparatus as claimed in claim 4, further comprising a central microprocessor unit connected with the switch unit, the central microprocessor unit serving to control all the units connected therewith and set the duration of lighting of the illuminating device, whereby according to the duration for which the switch unit is activated, the lighting duration of the illuminating device is adjusted via the central microprocessor unit.

20. The movable and delay-extinction illuminating apparatus as claimed in claim 17, wherein the central microprocessor unit is connected with a time display unit composed of several indicator lamps, whereby according to the duration for which the switch unit is activated, a certain number of indicator lamps will emit light to indicate the lighting duration of the lighting unit.

21. The movable and delay-extinction illuminating apparatus as claimed in claim 18, wherein the central microprocessor unit is connected with a time display unit composed of several indicator lamps, whereby according to the duration for which the switch unit is activated, a certain number of indicator lamps will emit light to indicate the lighting duration of the lighting unit.

22. The movable and delay-extinction illuminating apparatus as claimed in claim 19, wherein the central microprocessor unit is connected with a time display unit composed of several indicator lamps, whereby according to the duration for which the switch unit is activated, a certain number of indicator lamps will emit light to indicate the lighting duration of the lighting unit.

23. The movable and delay-extinction illuminating apparatus as claimed in claim 17, wherein the central microprocessor unit is further connected with an initial time selection unit for adjustably setting the lighting duration of the lighting unit when the switch unit is initially instantaneously once activated.

24. The movable and delay-extinction illuminating apparatus as claimed in claim 18, wherein the central microprocessor unit is further connected with an initial time selection unit for adjustably setting the lighting duration of the lighting unit when the switch unit is initially instantaneously once activated.

25. The movable and delay-extinction illuminating apparatus as claimed in claim 19, wherein the central microprocessor unit is further connected with an initial time selection unit for adjustably setting the lighting duration of the lighting unit when the switch unit is initially instantaneously once activated.

26. The movable and delay-extinction illuminating apparatus as claimed in claim 20, wherein the central microprocessor unit is further connected with an initial time selection unit for adjustably setting the lighting duration of the lighting unit when the switch unit is initially instantaneously once activated.

27. The movable and delay-extinction illuminating apparatus as claimed in claim 21, wherein the central microprocessor unit is further connected with an initial time selection unit for adjustably setting the lighting duration of the lighting unit when the switch unit is initially instantaneously once activated.

28. The movable and delay-extinction illuminating apparatus as claimed in claim 22, wherein the central microprocessor unit is further connected with an initial time selection unit for adjustably setting the lighting duration of the lighting unit when the switch unit is initially instantaneously once activated.

29. The movable and delay-extinction illuminating apparatus as claimed in claim 1, wherein the switch unit is disposed in the chamber of the housing, a transparent shade body being disposed on the housing, the shade body being inward pressable, one end of the shade body having at least one pivot section for pivotally connecting with the bottom of the housing, a touch section being disposed on the other end of the shade body nearly opposite to the pivot section, whereby when the shade body is inward pressed, the touch section presses and touches the switch unit to activate the illuminating unit.

30. The movable and delay-extinction illuminating apparatus as claimed in claim 4, wherein the switch unit is disposed in the chamber of the housing, a transparent shade body being disposed on the housing, the shade body being inward pressable, one end of the shade body having at least one pivot section for pivotally connecting with the bottom of the housing, a touch section being disposed on the other end of the shade body nearly opposite to the pivot section, whereby when the shade body is inward pressed, the touch section presses and touches the switch unit to activate the illuminating unit.

31. The movable and delay-extinction illuminating apparatus as claimed in claim 17, wherein the switch unit is disposed in the chamber of the housing, a transparent shade body being disposed on the housing, the shade body being inward pressable, one end of the shade body having at least one pivot section for pivotally connecting with the bottom of the housing, a touch section being disposed on the other end of the shade body nearly opposite to the pivot section, whereby when the shade body is inward pressed, the touch section presses and touches the switch unit to activate the illuminating unit.

32. The movable and delay-extinction illuminating apparatus as claimed in claim 18, wherein the switch unit is disposed in the chamber of the housing, a transparent shade body being disposed on the housing, the shade body being inward pressable, one end of the shade body having at least one pivot section for pivotally connecting with the bottom of the housing, a touch section being disposed on the other end of the shade body nearly opposite to the pivot section, whereby when the shade body is inward pressed, the touch section presses and touches the switch unit to activate the illuminating unit.

33. The movable and delay-extinction illuminating apparatus as claimed in claim 19, wherein the switch unit is disposed in the chamber of the housing, a transparent shade body being disposed on the housing, the shade body being inward pressable, one end of the shade body having at least one pivot section for pivotally connecting with the bottom of the housing, a touch section being disposed on the other end of the shade body nearly opposite to the pivot section, whereby when the shade body is inward pressed, the touch section presses and touches the switch unit to activate the illuminating unit.

34. The movable and delay-extinction illuminating apparatus as claimed in claim 20, wherein the switch unit is disposed in the chamber of the housing, a transparent shade body being disposed on the housing, the shade body being inward pressable, one end of the shade body having at least one pivot section for pivotally connecting with the bottom of the housing, a touch section being disposed on the other end of the shade body nearly opposite to the pivot section, whereby when the shade body is inward pressed, the touch section presses and touches the switch unit to activate the illuminating unit.

35. The movable and delay-extinction illuminating apparatus as claimed in claim 21, wherein the switch unit is disposed in the chamber of the housing, a transparent shade body being disposed on the housing, the shade body being inward pressable, one end of the shade body having at least one pivot section for pivotally connecting with the bottom of the housing, a touch section being disposed on the other end of the shade body nearly opposite to the pivot section, whereby when the shade body is inward pressed, the touch section presses and touches the switch unit to activate the illuminating unit.

36. The movable and delay-extinction illuminating apparatus as claimed in claim 22, wherein the switch unit is disposed in the chamber of the housing, a transparent shade body being disposed on the housing, the shade body being inward pressable, one end of the shade body having at least one pivot section for pivotally connecting with the bottom of the housing, a touch section being disposed on the other end of the shade body nearly opposite to the pivot section, whereby when the shade body is inward pressed, the touch section presses and touches the switch unit to activate the illuminating unit.

37. The movable and delay-extinction illuminating apparatus as claimed in claim 23, wherein the switch unit is disposed in the chamber of the housing, a transparent shade body being disposed on the housing, the shade body being inward pressable, one end of the shade body having at least one pivot section for pivotally connecting with the bottom of the housing, a touch section being disposed on the other end of the shade body nearly opposite to the pivot section, whereby when the shade body is inward pressed, the touch section presses and touches the switch unit to activate the illuminating unit.

38. The movable and delay-extinction illuminating apparatus as claimed in claim 24, wherein the switch unit is disposed in the chamber of the housing, a transparent shade body being disposed on the housing, the shade body being inward pressable, one end of the shade body having at least one pivot section for pivotally connecting with the bottom of the housing, a touch section being disposed on the other end of the shade body nearly opposite to the pivot section, whereby when the shade body is inward pressed, the touch section presses and touches the switch unit to activate the illuminating unit.

39. The movable and delay-extinction illuminating apparatus as claimed in claim 25, wherein the switch unit is disposed in the chamber of the housing, a transparent shade body being disposed on the housing, the shade body being inward pressable, one end of the shade body having at least one pivot section for pivotally connecting with the bottom of the housing, a touch section being disposed on the other end of the shade body nearly opposite to the pivot section, whereby when the shade body is inward pressed, the touch section presses and touches the switch unit to activate the illuminating unit.
